(19) United States
(12) Patent Application Publication
(10) Pub. No.: US 2011/0297009 A1
(43) Pub. Date: Dec. 8, 2011

(54) PULL-OUT GUIDE AND BAKING OVEN

(76) Inventor: Daniel Reidt, Herford (DE)

(21) Appl. No.: 13/127,931

(22) PCT Filed: Oct. 29, 2009
(86) PCT No.: PCT/EP09/64288

§ 371 Date: Aug. 29, 2011

(30) Foreign Application Priority Data
Nov. 7, 2008 (DE) 20 2008 014 790.5

(51) Int. Cl. F16C 29/04; A21B 1/00

(52) U.S. Cl. 99/352; 384/50

(57) ABSTRACT

A pullout guide for a baking oven, the pullout guide includes a guide rail, a movable rail mounted on the guide rail, the movable rail being movable via roller bodies guided along runways. The runways are located on at least one of the guide rail and the movable rail. The guide rail and the movable rail include a polytetrafluoroethylene-containing coating at least partially on an outer, externally accessible side of the guide rail and the movable rail, and the runways do not include the coating.

This application is a national stage of International Application PCT/EP2009/064288, filed Oct. 29, 2009, and claims benefit of and priority to German Patent Application No. 20 2008 041 790.5, filed Nov. 7, 2008, the content of which Applications are incorporated by reference herein.

### BACKGROUND AND SUMMARY

The present disclosure relates to a pullout guide, in particular a pullout guide for baking ovens. The pullout guide includes a guide rail on which guide rail at least one further rail is mounted so as to be movable via roller bodies. The roller bodies are guided along runways on the rails. The present disclosure also relates to a baking oven including the pullout guide.

EP 994309 discloses a telescopic pullout guide for a food support, in which multiple rails are mounted so they are displaceable relative to one another along sliding guides. The sliding guides are implemented from, or include, a heat-resistant sliding material. Such sliding guides have worse running properties than pullout guides having roller bodies and can easily jam in the event of soiling.

Furthermore, DE 10211470 discloses a pullout guide for food supports, in which a PTFE-containing coating is provided. On the one hand, the cleaning is to be made easier and, on the other hand, better smooth running of the pullout guide is to be achieved through the PTFE-containing coating, since the coating is supposed to cause noise damping. However, the coating in areas of the runways is problematic, because the roller bodies partially or completely remove the coating from the runways, and abraded material can occur, which can then reach the cooking area or even food as contamination. In addition, the powdered, abraded material can mix with lubricant and worsen the running quality. If the coating is removed in the area of the runways, the play also becomes greater, so that the smooth running and the running precision of the pullout guide decrease.

EP 1607685 also presumes that, in the case of a method for producing a pullout guide, the rails must first be completely provided over the entire surface with a primer coating, in order to then apply a PTFE-containing coating. The increased scratch resistance of the coating through primer coatings can slow the abrasion in the runways and perhaps prevent chips. However, worsening of the smooth running, in comparison to the uncoated pullout guide, which is already present in the new state, remains for baking ovens, since the runways are rougher and no longer so precise. Furthermore, wear of the coating can occur, whereby the pullout obtains more play in the course of the service life and the above-mentioned problems may occur.

The present disclosure thus relates to a pullout guide which is usable even in the case of extreme conditions, as in a baking oven, and has a long service life. In addition, the pullout guide is to be easy to clean.

The present disclosure relates to a pullout guide for a baking oven. The pullout guide includes a guide rail, a movable rail mounted on the guide rail, the movable rail being movable via roller bodies guided along runways. The runways are located on at least one of the guide rail and the movable rail. The guide rail and the movable rail include a polytetrafluoroethylene-containing coating at least partially on an outer, externally accessible side of the guide rail and the movable rail. The runways do not include the coating.

According to the present disclosure, the rails of the pullout guide are partially provided with a PTFE-containing coating on the outer side of the pullout guide, while the runways are implemented as coating-free. The pullout guide, therefore, has good running properties over its entire service life and in particular the wear on the runways cannot result in contamination of the surroundings. In addition, the pullout guide is easy to clean and can be used in extreme conditions, since the PTFE-containing coating on the outer side has an impregnating character.

According to an embodiment of the present disclosure, the outer side of the rails is provided over the entire surface with the PTFE-containing coating on the externally accessible area of the pullout guide. This ensures that no uncoated areas are provided on the outer side, which are difficult to clean.

The rails may be coating-free on the side facing toward the roller bodies. This ensures that a coating cannot unintentionally reach the runways, but rather the inner area of the pullout guide remains free of the coating, since this area is also rarely subjected to contaminants. Alternatively, according to the present disclosure, the rails may have coating-free strips in the area of the runways, which can be produced by covering the runways during the coating. A coating-free zone can thus be provided in a targeted way during the production of the rails.

A slide rail is may be provided. The slide rail may include a hollow profile open in the longitudinal pullout direction and therefore forms a hollow chamber, and on which hollow chamber three runways for roller bodies are included on an inner side. The slide rail has a U-shaped contour having legs of unequal length, so that an opening area through the slot is implemented as small as possible and the internal area of the pullout guide is protected from environmental influences.

The pullout guide can, according to the present disclosure, include only two rails as a partial pullout, but an embodiment having a guide rail, a middle rail, and a slide rail is within the scope of the present disclosure. Thus, a full pullout or even an extension pullout is achieved. The use of more than three rails is also within the scope of the present disclosure.

The present disclosure also relates to a baking oven in which the pullout guide according to the present disclosure is included on opposing sides of an inner chamber of the baking oven. The side wall or walls of the baking oven can, according to the present disclosure, be coated together with the pullout guide. The coating may be performed after the installation of the pullout guide.

Other aspects of the present disclosure will become apparent from the following descriptions when considered in conjunction with the accompanying drawings.

### BRIEF DESCRIPTION OF THE DRAWINGS

FIGS. 1 to 3 show multiple views of a first embodiment of a pullout guide, according to the present disclosure.

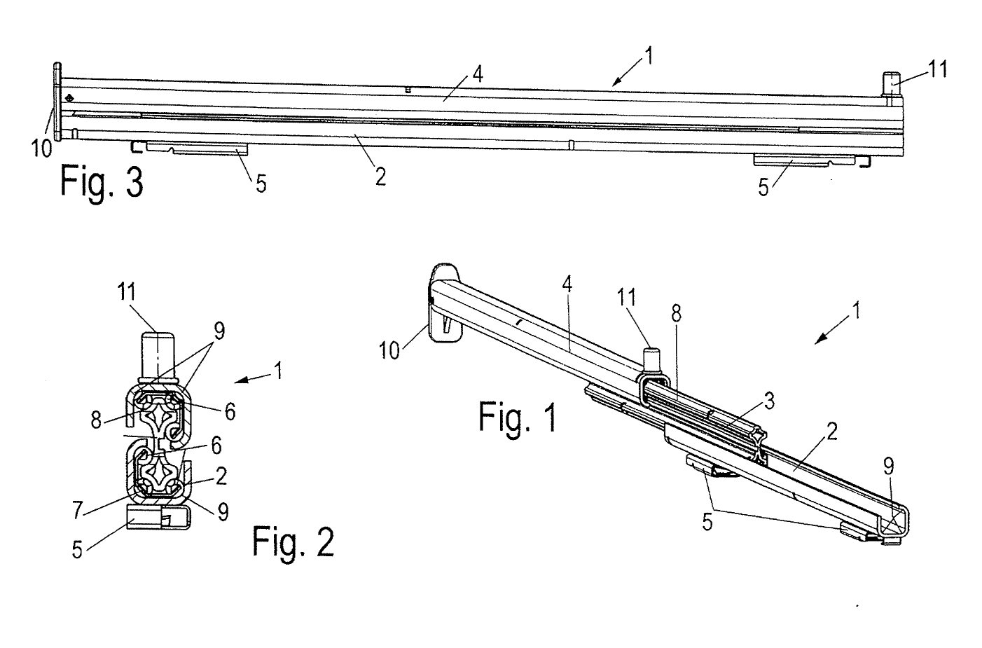

FIGS. 4 to 6 show multiple views of a second embodiment of a pullout guide, according to the present disclosure.

### DETAILED DESCRIPTION

A pullout guide 1 comprises a guide rail 2, which is fastenable on a side grating in a baking oven, a side wall of a baking oven, or a furniture body. A middle rail 3 is mounted so it is movable via roller bodies 6 on the guide rail 2. The middle rail 3 is used for mounting a slide rail 4. Three runways 8 for roller bodies 6 are included on the guide rail 2 and the slide rail 4 for mounting the rails 2, 3, and 4. The roller bodies 6 are held as a unit on a roller body cage 7. Furthermore, a total of six runways 8 for roller bodies 6 are included on the middle rail 3, three runways 8 being assigned to the guide rail 2 and three runways 8 being assigned to the slide rail 4.

Two clamps 5 are fixed on the guide rail 2 to fasten the pullout guide 1, for example, on a side grating of the baking oven. Other types of fasteners can also be provided on the guide rail 2, according to the present disclosure.

The pullout guide 1 is provided with a polytetrafluoroethylene or PTFE-containing coating on an externally accessible area, that is, on an outer side of the guide rail 2 and the slide rail 4. A plug 10, which is fixed on the slide rail 4, is also coated on its externally accessible areas using the PTFE-containing coating. A retaining pin 11 is also equipped with the PTFE-containing coating. The inner side of the slide rail 4 and the guide rail 2, on which the runways 9 for the roller bodies 6 are included, does not have a PTFE-containing coating. The middle rail 3, which is completely situated in an inner area of the pullout guide 1, when the slide rail 4 is situated in the retracted position, also does not have a PTFE-containing coating, at least in the area of the runways 8. The runways 8 can thus be formed by the material of the rails 2, 3, and 4. The runways 8 and 9 are typically produced from a curved steel plate. Easy cleaning is made possible on the outer side by the PTFE-containing coating on the rails 2 and 4. The pullout guide 1 can thus be used particularly well in a baking oven, resulting in a high running quality being achieved over a long service life.

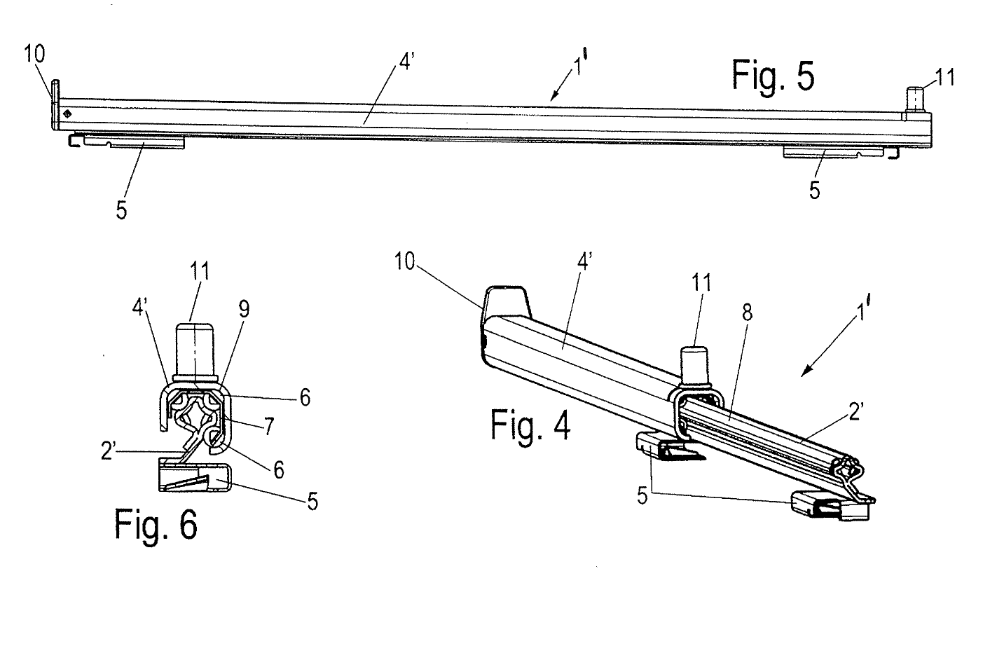

FIGS. 4 to 6 show a second embodiment of a pullout guide 1′, according to the present disclosure. The pullout guide 1′ includes a modified guide rail 2′, on which a slide rail 4′ is mounted so it is movable via roller bodies 6. The pullout guide 1′ is structured as a partial pullout and can also be installed via clamps 5 on a side grating of the baking oven. The slide rail 4′ has a substantially closed U-shaped contour, three runways 9 for roller bodies 6 being included in an inner chamber. The slide rail 4′ is coated on its outer side using the PTFE-containing coating. No coating is provided on the inner side.

The rails 2, 4, and 4′ may, according to the present disclosure, be coated when the pullout guide 1, 1′ is installed, such as when the rails 2, 3, 4 and 2′ and 4′ are positioned so they are movable on one another. A PTFE-containing coating can then be applied to the outer side by spraying. In addition, according to the present disclosure, it is possible to perform the coating on the outer side of the pullout guide 1, 1′ when the pullout guide 1, 1′ is already installed in an inner chamber of a baking oven. The pullout guide 1, 1′ can then be coated together with a side wall of the baking oven, so that both the side wall and also the pullout guide 1, 1′ are easy to clean. This allows effective production of a baking oven, in which pullout guides 1, 1′ having high running quality are used.

Although the present disclosure has been described and illustrated in detail, it is to be clearly understood that this is done by way of illustration and example only and is not to be taken by way of limitation. The scope of the present disclosure is to be limited only by the terms of the appended claims.

1. A pullout guide for a baking oven, the pullout guide comprising:
a guide rail;
a movable rail mounted on the guide rail, the movable rail being movable via roller bodies guided along runways, the runways being located on at least one of the guide rail and the movable rail; and
wherein the guide rail and the movable rail include a polytetrafluoroethylene-containing coating at least partially on an outer, externally accessible side of the guide rail and the movable rail, and the runways do not include the coating.

2. The pullout guide according to claim 1, wherein the coating is provided completely on the outer, externally accessible side of the guide rail and the movable rail.

3. The pullout guide according to claim 1, wherein the guide rail and the movable rail do not include the coating on a side facing toward the roller bodies.

4. The pullout guide according to claim 1, wherein guide rail and the movable rail include strips free of the coating in an area of the runways.

5. The pullout guide according to claim 1, wherein the movable rail includes a slide rail configured as to have hollow profile that is open in a longitudinal pullout direction and forms a hollow chamber, in which hollow chamber three runways for the roller bodies are located on an inner side.

6. The pullout guide according to claim 1, wherein the movable rail includes a middle rail is mounted to be movable on the guide rail and also includes a slide rail mounted to be movable on the middle rail, the middle rail being situated inside the guide rail and inside the slide rail.

7. A baking oven including the pullout guide of claim 1 mounted on opposite sides of an inner chamber of the baking oven.

8. The baking oven according to claim 7, wherein side walls of the baking oven are coated with the polytetrafluoroethylene-containing coating.
